(19) United States
(12) Patent Application Publication
(10) Pub. No.: US 2025/0256836 A1
(43) Pub. Date: Aug. 14, 2025

(54) CONNECTOR AND METHOD FOR CONNECTING MOTOR AND ARM OF MULTI-ROTOR AIRCRAFT

(71) Applicant: EHANG INTELLIGENT EQUIPMENT (GUANGZHOU) CO., LTD., Guangzhou (CN)

(72) Inventors: Huazhi HU, Guangzhou (CN); Danian HE, Guangzhou (CN); Xingjie LU, Guangzhou (CN); Guojun JIANG, Guangzhou (CN); Fansheng ZENG, Guangzhou (CN)

(73) Assignee: EHANG INTELLIGENT EQUIPMENT (GUANGZHOU) CO., LTD., Guangzhou (CN)

(21) Appl. No.: 19/079,515

(22) Filed: Mar. 14, 2025

Related U.S. Application Data
(63) Continuation of application No. PCT/CN2023/117534, filed on Sep. 7, 2023.

(30) Foreign Application Priority Data
Sep. 15, 2022 (CN) 202211123221.9
Sep. 15, 2022 (CN) 202222464166.1

(51) Int. Cl. B64C 11/48

(52) U.S. Cl. CPC B64C 11/48

(57) ABSTRACT

The provided is a connector and a method for connecting a motor and an arm of multi-rotor aircraft. The connector includes a base, a locking disc component, and a guiding positioning component; one side of the base is connected to the arm, the locking disc component includes a forward locking disc structure and a reverse locking disc structure; the guiding positioning component includes a forward guiding positioning structure and a reverse guiding positioning structure; the forward guiding positioning structure and the reverse guiding positioning structure are respectively embedded in the forward locking disc structure and the reverse locking disc structure, and one end of the forward locking disc structure is connected to a forward propeller motor, another end of the forward locking disc structure is inserted into a forward end of the base through the forward guiding positioning structure and connected to the forward end of the base.

### CROSS-REFERENCE TO THE RELATED APPLICATIONS

This application is a continuation application of International Application No. PCT/CN2023/117534, filed on Sep. 7, 2023, which is based upon and claims priority to Chinese Patent Application No. 202211123221.9, filed on Sep. 15, 2022; and Chinese Patent Application No. 202222464166.1, filed on Sep. 15, 2022, the entire contents of which are incorporated herein by reference.

### TECHNICAL FIELD

The present invention relates to the technical field of installation of a motor of an aircraft, particularly to a connector and a method for connecting a motor and an arm of multi-rotor aircraft.

### BACKGROUND

When connecting the motor of the multi-rotor aircraft to the arm of the multi-rotor aircraft, the following problems are often faced: not reliable connection between the motor and arm is, the complex and bulky connector between the motor and arm; and difficult production, installation, and positioning of the motor.

At present, the connection between the motor and the arm of multi-rotor aircraft is mostly based on the motor seat, using bolts installed radially on the stator of the motor or axially on the stator of the motor for fixing. However, in the operation of the propeller of multi-rotor aircraft, the coupling of complex aerodynamic forces, gyroscope precession, vibration and other conditions, and the stiffness and strength resonance of the motor arm connector, and the way of fixing via the radial installation of bolts on the stator of the motor makes multi-rotor aircraft prone to bolt loosening and fracture under complex multi physics field coupling.

To solve the above technical problems, the prior art discloses a mutually-embedded snap-fit double-insurance rapid disassemble and assemble structure for propellers of unmanned aerial vehicle, which faces the connection between the propeller and the upper cover of motor, including a propeller fixing component, a motor fixing component, and a positioning component. The dual fixation of the propeller and the upper cover of motor is achieved through the upper plate and a first fixture block, first slot, second fixture block, second slot, locking plate, movable shaft, pull ring, valute spiral spring, nut, waveform washer inside the base, etc. The dual circumferential positioning of the upper plate and the first fixture block, first slot, second fixture block, second slot inside the base can provide high concentricity, and simultaneously, can also be used when the propeller generates push-pull force. The first V-shaped protruding blocks at both ends of the locking plate is cooperated and fixed with the V-shaped grooves on the upper plate and the base, which reduce the radial clearance between the motor fixing component and the propeller fixing component, and eliminates the risk of the propeller loosening during forward and reverse rotation of the motor. However, due to the relatively fixed size of the motor, the space at the connection point of the motor fixing component is limited, resulting in difficulties in wiring and routing of the large wiring harness of the motor and in the operating of the torque wrench for the base of the motor and the motor.

### SUMMARY

In order to solve the problems of difficult installation and positioning, unstable connection with the arm, complex connectors, and difficulty in wiring and routing of the large wiring harness of the motor during the connection between the motor and the arm of the multi-rotor aircraft, the present invention proposes a connector and a method for connecting a motor and an arm of a multi-rotor aircraft. It can not only achieve the reliable installation of the motor of the multi-rotor aircraft, but also keep the stator of the motor from rotating during the locking connection, avoiding the phenomenon of the winding in wiring and routing of the wiring harness of the motor.

In order to achieve the above technical effects, the technical solution of the present invention is as follows:

A connector for connecting a motor and an arm of a multi-rotor aircraft; the connector includes a base, a locking disc component, and a guiding positioning component; one side of the base is connected to the arm; the motor of the multi-rotor aircraft includes a forward propeller motor and a reverse propeller motor; the locking disc component includes a forward locking disc structure and a reverse locking disc structure; the guiding positioning component includes a forward guiding positioning structure and a reverse guiding positioning structure; the forward guiding positioning structure and the reverse guiding positioning structure are respectively embedded in the forward locking disc structure and the reverse locking disc structure; one end of the forward locking disc structure is connected to the forward propeller motor; another end of the forward locking disc structure is inserted into a forward end of the base through the forward guiding positioning structure and connected to the forward end of the base through forward threads; one end of the reverse locking disc structure is connected to the reverse propeller motor, and another end of the reverse locking disc structure is inserted into a reverse end of the base through the reverse guiding positioning structure and connected to the reverse end of the base through reverse threads.

The connector proposed in this technical solution includes a base, a locking disc component, and a guiding positioning component. One end of the forward locking disc structure is connected to the forward propeller motor, and another end of the forward locking disc structure is inserted into the forward end of the base through the forward guiding positioning structure and connected to the forward end of the base through forward screw threads. Finally, it may be screwed into the base root using a customized torque wrench. During the screwing process, the guiding positioning component ensures accurate motor installation and positioning with no rotation of the stator of the motor and no winding of the wire harness. One side of the base is connected to the arm, and the motor of the multi-rotor aircraft is locked and connected to the arm of the multi-rotor aircraft. One end of the reverse locking disc structure is connected to the reverse propeller motor, and another end of the reverse locking disc structure is inserted into the reverse end of the base through the reverse guiding positioning structure and connected to the reverse end of the base through reverse threads. During the reverse screwing process, the guiding positioning component ensures accurate installation and positioning of the motor with no rotation of the stator of the motor and no winding of the wire harness.

Preferably, the base includes a connecting frame and a sleeve. One end of the connecting frame is connected to the arm, and another end of the connecting frame is vertically connected to the sleeve. A forward end of the sleeve is connected to the forward locking disc structure by forward threads, and a reverse end of the sleeve is connected to the reverse locking disc structure by reverse threads. As a whole, the threaded connection between the locking disc components and the base corresponds to the forward and reverse rotation of the propeller, ensuring that the locking disc components offset the torque of the propeller when the propeller rotates, so as to prevent the locking disc components from loosening from the base.

Preferably, the sleeve is provided with several inclined slots.

Here, in rotating direction of the rotor of motor of the multi-rotor aircraft and propeller of the multi-rotor aircraft, the stator of the motor is subjected to a reaction force, and the reaction force subjected by the rotor of the motor is transmitted to the base. The forward end and the reverse end of the base are respectively subjected to the reaction forces of the forward propeller motor and the reverse propeller motor. The directions of the two reaction forces are opposite, and the inclination direction of the inclined slot is provided to facilitate the bending resistance and torsion resistance of the base.

Preferably, each of the forward locking disc structure and the reverse locking disc structure includes a locking disc joint, and a locking disc body. A platform extends toward an axis of the sleeve along an inner wall of the sleeve, the platform is provided with several anti-rotation grooves, and the locking disc joint is provided with several anti-rotation bosses such that the anti-rotation bosses are arranged in the anti-rotation grooves when the locking disc joint is fitted onto the locking disc body.

Here, the anti-rotation bosses are provided on the locking disc joint, and the platform and the anti-rotation grooves are provided inside the base, such that the forward locking disc structure/reverse locking disc structure can achieve the anti-rotation function before being threadedly connected to the base. In this way, it can achieve that the locking disc joint keeps stationary, while the forward locking disc structure/reverse locking disc structure can move both axially and radially, achieving that the locking disc joint is threadedly locked by the forward locking disc structure/reverse locking disc structure.

Preferably, a guiding positioning groove is vertically provided along the inner wall of the sleeve, and the forward guiding positioning structure and the reverse guiding positioning structure respectively embedded in the forward locking disc structure and the reverse locking disc structure are guided into the sleeve through the guiding positioning groove.

Preferably, both the forward guiding positioning structure and the reverse guiding positioning structure are guiding positioning pins.

Preferably, the locking disc joint in the forward locking disc structure is connected to the forward propeller motor through bolts, and the locking disc joint in the reverse locking disc structure is connected to the reverse propeller motor through the bolts.

Here, after the locking disc joint is connected to the motor through bolts, the forward locking disc structure/reverse locking disc structure is threadedly connected and locked to the base. Under the threaded locking force of the forward locking disc structure/reverse locking disc structure, there is sufficient friction between the end face of the locking disc joint and the platform of the base, which, in addition to the anti-rotation bosses on the locking disc joint and the guiding positioning structure in the guiding positioning groove, ensures the firm and reliable installation of the motor and the base.

Preferably, the connector further includes several anti-loosening components. The outer side of the base is provided with several first fixing holes, and the locking disc body is provided with several second fixing holes, and each anti-loosening component sequentially passes through one first fixing hole on the base and one second fixing hole on the locking disc body before locking the locking disc body to the base, which ensures the firm and reliable installation of the motor and the base.

Preferably, the anti-loosening component is an anti-loosening fuse.

The present application also proposes a method for connecting a motor and an arm of a multi-rotor aircraft, the motor of the multi-rotor aircraft includes a forward propeller motor and a reverse propeller motor, the method comprises sequentially connecting the forward propeller motor to the arm and the reverse propeller motor to the arm, the method includes steps of:
S1. connecting one end of a forward locking disc structure to the forward propeller motor, and inserting another end of the forward locking disc structure into a forward end of the base through the forward guiding positioning structure, and connecting another end of the forward locking disc structure to the forward end of the base through forward threads;
S2. connecting one side of the base to the arm;
S3. using a customized torque wrench to screw the forward locking disc structure into a root of the base;
S4. connecting one end of a reverse locking disc structure to the reverse propeller motor, and inserting another end of the reverse locking disc structure into a reverse end of the base through the reverse guiding positioning structure, and connecting another end of the reverse locking disc structure to the reverse end of the base through reverse threads;
S5. using the customized torque wrench to screw the reverse locking disc structure into the root of the base.

Compared with the existing technology, the beneficial effects of the technical solution of the present invention are as follows:

The present invention proposes a connector for connecting a motor and an arm of a multi-rotor aircraft. The connector includes a base, a locking disc component, and guiding positioning component. One end of the forward locking disc structure is connected to a forward propeller motor, and another end of the forward locking disc structure is inserted into the forward end of the base and connected to the forward end of the base 1 through forward threads, until another end of the forward locking disc structure 21 is screwed into the root of the base. During the screwing process, the stator of the motor does not rotate, with no winding of the wiring harness. One side of the base is connected to the arm, and the motor of the multi-rotor aircraft is tightly connected to the arm. One end of the reverse locking disc structure is connected to the reverse propeller motor, and another end of the reverse locking disc structure is inserted into the reverse end of the base through the reverse guiding positioning structure and connected to the reverse end of the base through reverse threads. During the reverse screwing process, the guiding positioning component ensures accurate motor installation and positioning, with no rotation of the stator of the motor and no winding of the wire harness.

### BRIEF DESCRIPTION OF THE DRAWINGS

FIG. 1 shows a schematic diagram of an overall structure of the connector between a motor and an arm of a multi-rotor aircraft proposed in embodiment 1 of the present invention;

FIG. 2 shows an exploded view of the structure of the connector between the motor and the arm of the multi-rotor aircraft proposed in embodiment 1 of the present invention;

FIG. 3 shows a cross-sectional view of the connector between the multi-rotor aircraft motor and the arm proposed in embodiment 1 of the present invention;

FIG. 4 shows a schematic diagram of the rotation direction of rotor of the motor and the direction of the reaction force subjected by the rotor of the motor on the connector between the motor and the arm of the multi-rotor aircraft proposed in embodiment 2 of the present invention;

FIG. 5 shows a schematic flow chart shows the connection between the motor and the arm of a multi-rotor aircraft proposed in embodiment 3 of the present invention.

Among them, 1—base; 2—locking disc component; 3—guiding positioning component; 21—forward locking disc structure; 22—reverse locking disc structure; 31—forward guiding positioning structure; 32—reverse guiding positioning structure; 11—connecting frame 12—sleeve; 121 inclined slot; 201—locking disc joint; 202—locking disc body; 122—platform; 123—anti-rotation groove; 203—anti-rotation boss; 124 guiding positioning groove; 4—anti-loosening component; 13—first fixing hole; 204—second fixing hole; 5—anti-loosening hexagon bolt.

### DETAILED DESCRIPTION OF THE EMBODIMENTS

The accompanying drawings are for illustrative purposes only and should not be construed as limiting the scope of this patent;

In order to better illustrate the present embodiments, some components in the accompanying drawings may be omitted, zoomed in or zoomed out, and do not represent the actual size.

For those of ordinary skill in the art, it is understandable that description for some well-known content in the accompanying drawings may be omitted.

The technical solution of the present invention will be further explained in conjunction with the accompanying drawings and embodiments.

The description of the positional relationship in the accompanying drawings is for illustrative purposes only and should not be construed as a limitation on this patent.

### Embodiment 1

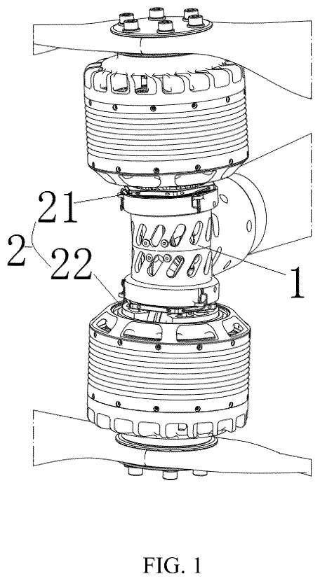

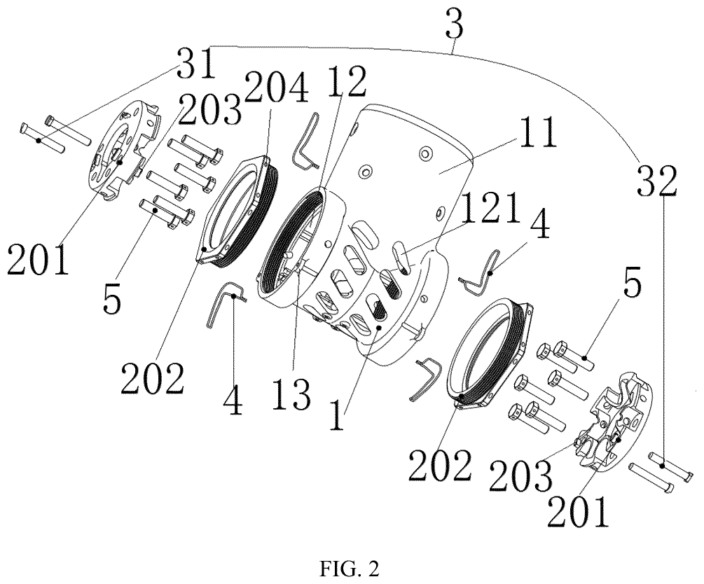

As shown in FIGS. 1 and 2, this embodiment proposes connector for connecting a motor and an arm of a multi-rotor aircraft, which includes a base 1, a locking disc component 2, and a guiding positioning component 3. One side of the base 1 is connected to the arm, and the locking disc component 2 includes a forward locking disc structure 21 and a reverse locking disc structure 22. The guiding positioning component 3 includes a forward guiding positioning structure 31 and a reverse guiding positioning structure 32. The forward guiding positioning structure 31 and the reverse guiding positioning structure 32 are embedded in the forward locking disc structure 21 and the reverse locking disc structure 22, respectively. One end of the forward locking disc structure 21 is connected to the forward propeller motor, and another end of the forward locking disc structure 21 is inserted into the forward end of the base 1 through the forward guiding positioning structure 31 and connected to the forward end of the base 1 through forward threads. One end of the reverse locking disc structure 22 is connected to the reverse propeller motor, and another end the reverse locking disc structure 22 is inserted into a reverse end of the base 1 through the reverse guiding positioning structure 32 and connected to the reverse end of the base 1 through reverse threads. The guiding positioning component 3 ensures accurate installation and positioning of the motor.

Referring to FIG. 1, the base 1 includes a connecting frame 11 and a sleeve 12. One end of the connecting frame 11 is connected to the arm, and another end of the connecting frame 11 is vertically connected to the sleeve 12. The forward end of the sleeve 12 is connected to the forward locking disc structure 21 through forward threads, and the reverse end of the sleeve 12 is connected to the reverse locking disc structure 22 through reverse threads.

In the present embodiment, both the forward guiding positioning structure 31 and the reverse guiding positioning structure 32 are guiding positioning pins.

The connector proposed in the present embodiment includes a base 1, and a locking disc component 2. One end of the forward locking disc structure 21 is connected to a forward propeller motor, and another end of the forward locking disc structure 21 is inserted into the forward end of the base 1 and connected to the forward end of the base 1 through forward threads, until another end of the forward locking disc structure 21 is screwed into the root of the motor connection base. During the screwing process, the stator of the motor does not rotate, with no winding of the wiring harness. One side of the base 1 is connected to the arm, and the motor of the multi-rotor aircraft is tightly connected to the arm. One end of the reverse locking disc structure 22 is connected to the reverse propeller motor, and another end of the reverse locking disc structure 22 is inserted into the reverse end of the base 1 and connected to the reverse end of the base 1 through reverse threads. During the reverse screwing process, the stator of the motor does not rotate, with no winding of the wiring harness.

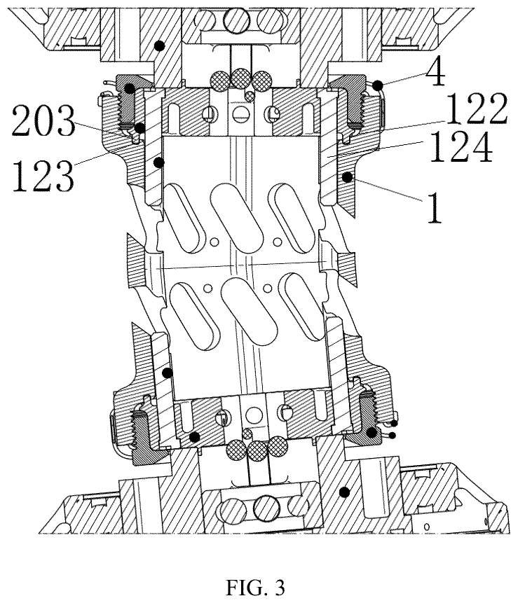

Referring to FIGS. 2 and 3, each of the forward locking disc structure 21 and the reverse locking disc structure 22 includes a locking disc joint 201, and a locking disc body 202. A platform 122 extends toward an axis of the sleeve 12 along an inner wall of the sleeve 12. The platform 122 is provided with several anti-rotation grooves 123, and the locking disc joint 202 is provided with several anti-rotation bosses 203 such that the anti-rotation bosses 203 are arranged in the anti-rotation grooves 123 when the locking disc joint 201 is fitted onto the locking disc body 202.

The anti-rotation bosses 201 are provided on the locking disc joint 203, and the platform 122 and the anti-rotation grooves 123 are provided inside the base 1, such that the forward locking disc structure/reverse locking disc structure can achieve the anti-rotation function before being threadedly connected to the base. In this way, it can achieve that the locking disc joint keeps stationary, while the forward locking disc structure/reverse locking disc structure can move both axially and radially, achieving that the locking disc joint is threadedly locked by the forward locking disc structure/reverse locking disc structure 22.

As shown in FIG. 3, a guiding positioning groove 124 is further vertically provided along the inner wall of the sleeve 12, and the forward guiding positioning structure 31 and the reverse guiding positioning structure 32 respectively embedded in the forward locking disc structure 21 and the reverse locking disc structure 22 are guided into the sleeve 12 through the guiding positioning groove 124, ensuring accurate installation and positioning of the motor.

The locking disc joint 201 in the forward locking disc structure 21 is connected to the forward propeller motor through bolts, and the locking disc joint 201 in the reverse locking disc structure 22 is connected to the reverse propeller motor through bolts. In the present embodiment, the locking disc joint 201 is connected to the motor through anti-loosening hexagon bolts 5. The forward locking disc structure 21/reverse locking disc structure 22 threadedly connected and locked to the base 1. Under the threaded locking force of the forward locking disc structure 21/reverse locking disc structure 22, there is sufficient friction between the end face of the locking disc joint 201 and the platform of the base 1, which, in addition to the anti-rotation bosses 203 on the locking disc joint 201 and the guiding positioning structure in the guiding positioning groove 124, ensures the firm and reliable installation of the motor and the base 1.

Referring to FIG. 2, the connector further includes several anti-loosening components 4. The outer side of the base 1 is provided with several first fixing holes 13, and the locking disc body 202 is provided with several second fixing holes 204. Each anti-loosening component 4 sequentially passes through one first fixing hole 13 on the base 1 and one second fixing hole 204 on the locking disc body before locking the locking disc body to the base 1. In the present embodiment, the anti-loosening component 4 is an anti-loosening fuse.

In specific implementation, in combination with the content of embodiment 1, the forward guiding positioning structure 31 is installed on the locking disc joint 201, and the locking disc joint 201 is fitted onto the locking disc body 202, and then the assembly of the locking disc joint 201 and locking disc body 202 is defined as a first assembly. The first assembly is connected to the forward propeller motor through anti-loosening hexagon bolts, and of course, the ways of the locking is not limited when actual implemented, and the assembled part above is defined as a second assembly. One end of the connecting frame 11 of the motor connection base 1 is installed with the arm through adhesive and rivets, and the above part is defined as a third assembly. The locking disc body 202 of the second assembly is coated with anaerobic adhesive and is inserted into the forward end of the base 1 of the third assembly through the guiding and positioning of the forward guiding positioning structure 31. Then, it is screwed into the root of the motor connection base using a customized torque wrench. During the screwing process, the stator of the motor always remains stationary with no rotation all the time, such that there is no winding of wiring harness of the motor. Finally, the locking disc body 202 is locked tightly, and the forward rotating motor that is assembled completely is defined as a fourth assembly.

For the assembly of the reverse propeller motor part: another set, namely the reverse guiding positioning structure 32 is installed on another locking disc joint 201, and inserted into the locking disc body 202, and the assembly of the locking disc joint 201 and locking disc body 202 is defined as the fifth assembly. The fifth assembly is locked and connected to the reverse propeller motor through another set of anti-loosening hexagon bolts 5. Of course, the ways of the locking is not limited when actual implemented, and the assembled part above defined as a sixth assembly. The sixth assembly is inserted into the reverse end of the base 1 of the fourth assembly through the guiding and positioning of the reverse guiding positioning structure 32, and then it is screwed into the root of base 1 using a customized torque wrench. During the screwing process, the stator of the motor always remains stationary with no rotation, such that there is no winding of wiring harness of the motor, and the locking disc body is locked on this side. The assembly of the reverse propeller motor part is completed. Finally, anti-loosening fuses are installed between the locking disc bodies 202 in both directions and the base 1. However, in actual implementation, it is not limited to this way of anti-loosening. The connection and installation of the entire motor and the arm of the multi-rotor aircraft is completed.

### Embodiment 2

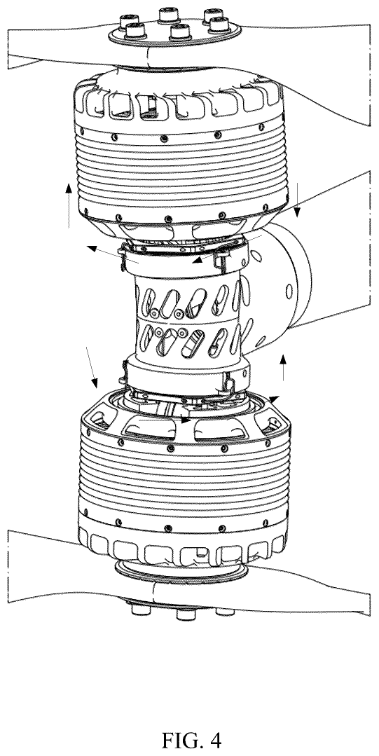

In the present embodiment, based on the basic structure of the connector in embodiment 1, it is proposed that several inclined slots 121 are provided on the sleeve 12. In rotating direction of the rotor of motor of the multi-rotor aircraft and propeller of the multi-rotor aircraft, the stator of the motor is subjected to a reaction force, and the reaction force subjected by the rotor of the motor is transmitted to the base 1. The forward end and the reverse end of the base 1 are respectively subjected to the reaction forces of the forward propeller motor and the reverse propeller motor. FIG. 4 is a schematic diagram of the rotation direction of the rotor of the motor and the direction of the reaction force subjected by the stator of the motor on the connector between the motor and the arm of the multi-rotor aircraft. The “arrow” represents the general direction of the reaction force subjected by the stator of the motor, and it can be seen that the directions of the two reaction forces are opposite., it can be concluded from FIG. 3 that the provided inclination direction of the inclined slot 121 facilitates the bending resistance and torsion resistance of the base 1.

### Embodiment 3

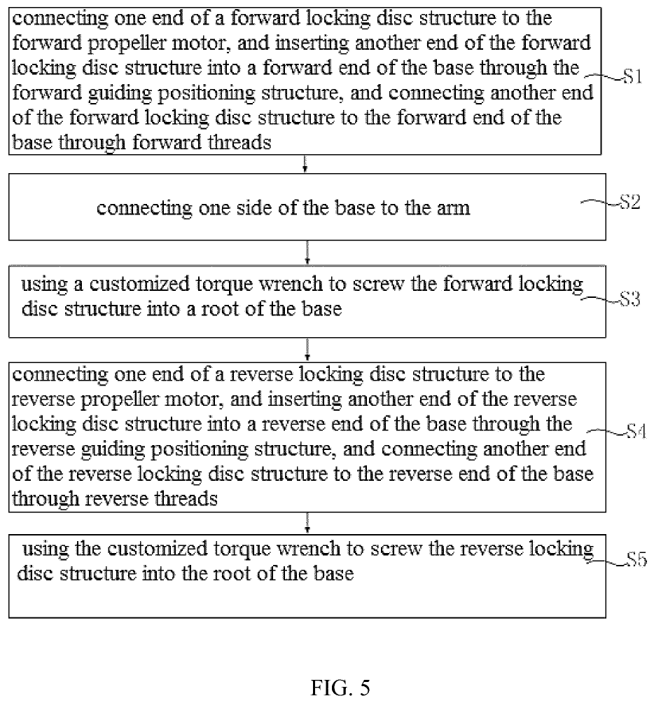

As shown in FIG. 5, the present embodiment proposes a method for connecting motor and an arm of multi-rotor aircraft, the motor of the multi-rotor aircraft includes a forward propeller motor and a reverse propeller motor, the method comprises sequentially connecting the forward propeller motor to the arm and the reverse propeller motor to the arm, the method includes steps of:
S1. connecting one end of a forward locking disc structure 21 to the forward propeller motor, and inserting another end of the forward locking disc structure 21 into a forward end of the base 1 through the forward guiding positioning structure 31, and connecting another end of the forward locking disc structure 21 to the forward end of the base 1 through forward threads;
S2. connecting one side of the base 1 to the arm;
S3. using a customized torque wrench to screw the forward locking disc structure 21 into a root of the base 1;
S4. connecting one end of the reverse locking disc structure 22 to the reverse propeller motor, and inserting another end of the reverse locking disc structure 22 into the reverse end of the base 1 through the reverse guiding positioning structure 32, and connecting another end of the reverse locking disc structure 22 to the reverse end of the base 1 through reverse threads;
S5. using the customized torque wrench to screw the reverse locking disc structure 22 into the root of the base 1.

In specific implementation, in combination with the content of embodiment 1, as for the assembling of the forward propeller motor part, the forward guiding positioning structure 31 is installed on the locking disc joint 201, and the locking disc joint 201 is fitted onto the locking disc body 202, and then the assembly of the locking disc joint 201 and locking disc body 202 is defined as a first assembly. The first assembly is connected to the forward propeller motor through anti-loosening hexagon bolts, and of course, the ways of the locking are not limited when actual implemented, and the assembled part above is defined as a second assembly. One end of the connecting frame 11 of the base 1 is installed with the arm through adhesive and rivets, and the above part is defined as a third assembly. The locking disc body 202 of the second assembly is coated with anaerobic adhesive and is inserted into the forward end of the base 1 of the third assembly through the guiding and positioning of the forward guiding positioning structure 31. Then, it is screwed into the root of the motor connection base using a customized torque wrench. During the screwing process, the stator of the motor always remains stationary with no rotation, such that there is no winding of wiring harness of the motor. Finally, the locking disc body 202 is locked tightly, and the forward rotating motor that is assembled completely is defined as a fourth assembly.

For the assembly of the reverse propeller motor part: another set, namely the reverse guiding positioning structure 32 is installed on another locking disc joint 201, and inserted into the locking disc body 202, and the assembly of the locking disc joint 201 and locking disc body 202 is defined as the fifth assembly. The fifth assembly is locked and connected to the reverse propeller motor through another set of anti-loosening hexagon bolts 5. Of course, the ways of the locking is not limited when actual implemented, and the assembled part above defined as a sixth assembly. The sixth assembly is inserted into the reverse end of the base 1 of the fourth assembly through the guiding and positioning of the reverse guiding positioning structure 32, and then it is screwed into the root of base 1 using a customized torque wrench. During the screwing process, the stator of the motor always remains stationary with no rotation, such that there is no winding of wiring harness of the motor, and the locking disc body is locked tightly on this side. The assembly of the reverse propeller motor part is completed. Finally, anti-loosening fuses are installed between the locking disc bodies 202 in both directions and the base 1. However, in actual implementation, it is not limited to this way of anti-loosening. The connection and installation of the entire motor and the arm of the multi-rotor aircraft is completed.

Obviously, the above embodiments of the present invention are only examples provided to clearly illustrate the present invention, and are not limitations on the embodiments of the present invention. Those of ordinary skill in the art may also make other changes or variations in different forms on the basis of the above description. It is unnecessary and impossible to enumerate all embodiments herein. Any modifications, equivalent substitutions, improvements, etc. made within the spirit and principle of the present invention should be included within the scope of protection of the claims of the present invention.

What is claimed is:

1. A connector for connecting a motor and an arm of a multi-rotor aircraft, wherein the connector comprises a base, a locking disc component, and a guiding positioning component,
one side of the base is connected to the arm, the motor of the multi-rotor aircraft comprises a forward propeller motor and a reverse propeller motor, the locking disc component comprises a forward locking disc structure and a reverse locking disc structure, the guiding positioning component comprises a forward guiding positioning structure and a reverse guiding positioning structure, the forward guiding positioning structure and the reverse guiding positioning structure are respectively embedded in the forward locking disc structure and the reverse locking disc structure, and a first end of the forward locking disc structure is connected to the forward propeller motor, a second end of the forward locking disc structure is inserted into a forward end of the base through the forward guiding positioning structure and connected to the forward end of the base through first forward threads;
a first end of the reverse locking disc structure is connected to the reverse propeller motor, and a second end of the reverse locking disc structure is inserted into a reverse end of the base through the reverse guiding positioning structure and connected to the reverse end of the base through first reverse threads.

2. The connector for connecting the motor and the arm of the multi-rotor aircraft according to claim 1, wherein the base comprises a connecting frame and a sleeve, a first end of the connecting frame is connected to the arm, a second end of the connecting frame is vertically connected to the sleeve, a forward end of the sleeve is connected to the forward locking disc structure by second forward threads, and a reverse end of the sleeve is connected to the reverse locking disc structure by second reverse threads.

3. The connector for connecting the motor and the arm of the multi-rotor aircraft according to claim 2, wherein the sleeve is provided with a plurality of inclined slots.

4. The connector for connecting the motor and the arm of the multi-rotor aircraft according to claim 2, wherein each of the forward locking disc structure and the reverse locking disc structure comprises a locking disc joint, and a locking disc body, a platform extends toward an axis of the sleeve along an inner wall of the sleeve, wherein the platform is provided with a plurality of anti-rotation grooves, and the locking disc joint is provided with a plurality of anti-rotation bosses, wherein the plurality of anti-rotation bosses are arranged in the plurality of anti-rotation grooves when the locking disc joint is fitted onto the locking disc body.

5. The connector for connecting the motor and the arm of the multi-rotor aircraft according to claim 4, wherein a guiding positioning groove is vertically provided along the inner wall of the sleeve, and the forward guiding positioning structure and the reverse guiding positioning structure respectively embedded in the forward locking disc structure and the reverse locking disc structure are guided into the sleeve through the guiding positioning groove.

6. The connector for connecting the motor and the arm of the multi-rotor aircraft according to claim 5, wherein both the forward guiding positioning structure and the reverse guiding positioning structure are guiding positioning pins.

7. The connector for connecting the motor and the arm of the multi-rotor aircraft according to claim 4, wherein the locking disc joint in the forward locking disc structure is connected to the forward propeller motor through first bolts, and the locking disc joint in the reverse locking disc structure is connected to the reverse propeller motor through second bolts.

8. The connector for connecting the motor and the arm of the multi-rotor aircraft according to claim 4, wherein the connector further comprises a plurality of anti-loosening components, wherein an outer side of the base is provided with a plurality of first fixing holes, and the locking disc body is provided with a plurality of second fixing holes, and each of the plurality of anti-loosening components sequentially passes through one first fixing hole on the base and one second fixing hole on the locking disc body before locking the locking disc body to the base.

9. The connector for connecting the motor and the arm of the multi-rotor aircraft according to claim 8, wherein each of the plurality of anti-loosening components is an anti-loosening fuse.

10. A method for connecting a motor and an arm of a multi-rotor aircraft, wherein the motor of the multi-rotor aircraft comprises a forward propeller motor and a reverse propeller motor, the method comprises sequentially connecting the forward propeller motor to the arm and the reverse propeller motor to the arm, the method comprises steps of:
S1. connecting a first end of a forward locking disc structure to the forward propeller motor, and inserting a second end of the forward locking disc structure into a forward end of a base through a forward guiding positioning structure, and connecting the second end of the forward locking disc structure to the forward end of the base through forward threads;
S2. connecting one side of the base to the arm;
S3. using a predetermined torque wrench to screw the forward locking disc structure into a root of the base;
S4. connecting a first end of a reverse locking disc structure to the reverse propeller motor, and inserting a second end of the reverse locking disc structure into a reverse end of the base through a reverse guiding positioning structure, and connecting the second end of the reverse locking disc structure to the reverse end of the base through reverse threads;
S5. using the predetermined torque wrench to screw the reverse locking disc structure into the root of the base.
